(19) United States
(12) Patent Application Publication
(10) Pub. No.: US 2009/0175146 A1
(43) Pub. Date: Jul. 9, 2009

(54) Data Recording/Reproducing Method and Apparatus

(76) Inventors: Jeong Uk Lee, Seoul (KR); Jeong Kyo Seo, Gyeonggi-do (KR)

Correspondence Address: HARNESS, DICKEY & PIERCE, P.L.C., P.O. BOX 8910, RESTON, VA, 20195, US

(21) Appl. No.: 12/225,590

(22) PCT Filed: Mar. 13, 2007
(86) PCT No.: PCT/KR2007/001223

§ 371 Date: Sep. 25, 2008

(30) Foreign Application Priority Data
Apr. 4, 2006 (KR) 10-2006-0030659
Jul. 11, 2006 (KR) 10-2006-0064864

(51) Int. Cl. G11B 27/36

(52) U.S. Cl. 369/53.3; G9B/27.052

(57) ABSTRACT

A data recording/reproducing method and apparatus which are capable of accurately and stably controlling a gap between a recording medium and a head of the data recording/reproducing apparatus are disclosed. The data recording/reproducing method includes: outputting at least one signal based on a light beam reflected from a recording medium; detecting a minimum value and a maximum value of the output signal; and adjusting a gap between a head of a data recording/reproducing apparatus and the recording medium according to the minimum value and the maximum value.

### TECHNICAL FIELD

The present invention relates to data record/reproduction, and more particularly to a method and apparatus for recording/reproducing data on/from a recording medium.

### BACKGROUND ART

Generally, an optical recording/reproducing apparatus records/reproduces data on/from a disc such as a compact disc (CD) or a digital versatile disc (DVD). As the preferences of consumers have changed, a technology for processing a high-definition moving image is required. In addition, as a moving-image compression technology has been developed, a high-density recording medium is required. A technology related to an optical head is necessary for developing the high-density recording medium.

The recording density of the recording medium depends on the diameter of a spot of a light beam used for record and reproduction. That is, as the size of the spot of the light beam irradiated onto and focused on the recording medium is small, the recording density increases. The size of the spot of the focused light beam is determined by two factors including numerical aperture (NA) of a lens used in focusing and the wavelength of the light beam focused by the lens. Accordingly, in order to increase the recording density of the recording medium, a light beam having a short wavelength is used. However, since a far field recording head using a general lens has a light diffraction limitation, there is a limit to reduce the size of the spot of the light beam. A near field recording (NFR) apparatus capable of storing and reading information in a unit smaller than the wavelength of the light beam based on near field optics is being developed.

FIG. 1 is a view showing an optical system of a conventional near field recording/reproducing apparatus. As shown in FIG. 1, a head of the near field recording/reproducing head includes an objective lens 1 and a near field generator 2. The near field generator 2 is located adjacent to a recording medium 3. The near field generator 2 includes a minute slot having a size less than the wavelength of light beam. The slot is closely located adjacent to the recording medium 3.

The light beam emitted from a light source is focused by the objective lens 1 and converted into an evanescent wave by the near field generator 2. Data recording using the evanescent wave is referred to as near field optical recording. In the near field optical recording, the size of a recording mark is determined by the size of the slot, not by the wavelength of the light beam. In the far field, air having a refractive index of 1 between the slot and an optical focal point is considered. However, in the near field optical recording, since the near field generator 2 and the recording medium 3 are located closely adjacent to each other, the refractive index of air between the slot and the optical focal point is ignored. In this case, since the size of the spot is determined by the refractive index of the near field generator 2, it is possible to obtain a spot having a small size by increasing the refractive index of the near field generator 2.

In the conventional near field recording/reproducing apparatus, the near field generator 2 must be located closely adjacent to the recording medium 3 at a proper gap such that they do not contact or collide with each other. For example, when a gap error signal (GES) is not accurately detected in a gap servo process for allowing the near field generator 2 to approach the recording medium 3, the near field generator 2 and the recording medium 3 may contact or collide with each other or a gap between the near field generator 2 and the recording medium 3 may excessively increase. As shown in FIG. 2, for example, when a large variation (e.g., X-talk) in the amplitude of a tracking error signal (TES) detected for determining whether a light beam is deviated from a track of the recording medium 3 interferes with the GES, a certain area of the GES is amplified due to an interference component and thus it is determined that the gap between the near field generator 2 and the recording medium 3 is large. Accordingly, the near field generator 2 may contact or collide with the recording medium 3 by readjusting the gap.

As shown in FIG. 3, when the gap servo process starts, an overshoot phenomenon that the amplitude of the GES increases occurs. Accordingly, the gap between the near field generator 2 and the recording medium 3 may be erroneously measured.

### DISCLOSURE OF INVENTION

Accordingly, the present invention is directed to a data recording/reproducing method and apparatus that substantially obviate one or more problems due to limitations and disadvantages of the related art.

An object of the present invention devised to solve the problem lies on a data recording/reproducing method and apparatus which are capable of accurately and stably controlling a gap between a recording medium and a head of the data recording/reproducing apparatus.

The object of the present invention can be achieved by providing a data recording/reproducing method comprising: outputting at least one signal based on a light beam reflected from a recording medium; detecting a minimum value and a maximum value of the output signal; and adjusting a gap between a head of a data recording/reproducing apparatus and the recording medium according to the minimum value and the maximum value.

The step of outputting at least one signal may comprise outputting an RF signal indicating the amount of the light beam incident to the recording medium, a gap error signal indicating whether a spot of the light beam incident to the recording medium is focused and the gap between the head and the recording medium, and a tracking error signal indicating whether the head is eccentric.

The step of adjusting the gap between the head and the recording medium according to the minimum value and the maximum value may comprise comparing the minimum value and the maximum value with a lower reference value and an upper reference value, respectively; and adjusting the gap between the head and the recording medium according to the result of comparison.

The data recording/reproducing method may further comprise adjusting the gap between the head and the recording medium on the basis of vertical symmetry of the output signal. The vertical symmetry of the output signal may be determined by determining whether a difference between the maximum value and an average value of the output signal and a difference between the average value and the minimum value are identical.

In another aspect of the present invention, provided herein is a data recording/reproducing apparatus comprising: a head for irradiating a light beam onto a recording medium and receiving the light beam reflected from the recording medium; a signal output unit for outputting at least one signal on the basis of the light beam reflected from the recording medium; a head carrying unit for moving the head; and a control unit for adjusting a gap between the head and the recording medium according to a minimum value and a maximum value of the signal output from the signal output unit.

In yet another aspect of the present invention, provided herein is a data recording/reproducing method comprising: setting a gap reference value between a head of a data recording/reproducing apparatus and a recording medium; outputting a signal based on a light beam reflected from the recording medium; determining whether noise is included in the output signal; and adjusting the gap reference value according to the result of determination.

The step of determining whether noise is included in the output signal may comprise determining whether the noise is included on the basis of a difference between a maximum value and a minimum value of the output signal. The data recording/reproducing method may further comprise adjusting the gap reference value on the basis of the maximum value and the minimum value of the output signal, when the noise is included in the output signal.

In yet another aspect of the present invention, provided herein is a data recording/reproducing apparatus comprising: a signal output unit for outputting a signal indicating a gap between a head and a recording medium; and a control unit for initially setting a gap reference value between the head and the recording medium and adjusting the gap reference value depending on whether noise is included in the signal output from the signal output unit.

In yet another aspect of the present invention, provided herein is a data recording/reproducing method comprising: outputting a signal based on a light beam reflected from a recording medium; removing noise included in the signal according to a variation in the level of the signal; and controlling a gap between a pickup of a data recording/reproducing apparatus and the recording medium according to the signal from which the noise is removed.

The removing step may comprise determining whether the noise is included in the signal on the basis of the variation in the level of the signal; decreasing a maximum value of the signal to be smaller than a reference value when the noise is included in the signal; and adjusting a gain of the signal from which the noise is removed.

In yet another aspect of the present invention, provided herein is a data recording/reproducing apparatus comprising: a pickup for irradiating a light beam onto a recording medium and receiving the light beam reflected from the recording medium; a signal correcting unit for removing noise included in a signal according to a variation in the level of a signal detected from the light beam reflected from the recording medium; a pickup carrying unit for moving the pickup; and a control unit for controlling a gap between the pickup and the recording medium according to the signal from which the noise is removed.

In yet another aspect of the present invention, provided herein is a data recording/reproducing method comprising: primarily allowing a pickup of a data recording/reproducing apparatus to approach a recording medium to reach a position having a first reference gap; performing a tracking servo process such that the pickup traces a track of the recording medium when the pickup reaches the position having the first reference gap; and secondarily allowing the pickup to approach the recording medium to reach a position having a second reference gap when the pickup traces the track of the recording medium.

The step of secondarily allowing the pickup to approach the recording medium may comprise secondarily allowing the pickup to approach the recording medium at a speed lower than that of the primary approaching step.

At least one of the steps of primarily and secondarily allowing the pickup to approach the recording medium may comprise outputting a signal based on a light beam reflected from the recording medium; and removing noise included in the signal according to a differential value of the signal.

In yet another aspect of the present invention, provided herein is a data recording/reproducing apparatus comprising: a pickup carrying unit for primarily allowing a pickup to approach a recording medium to reach a position having a first reference gap and secondarily allowing the pickup to approach the recording medium to reach a position having a second reference gap; and a control unit for controlling the pickup carrying unit such that the pickup traces a track of the recording medium, when the pickup reaches the position having the first reference gap, and controlling the pickup carrying unit such that the pickup reaches the position having the second reference gap, when the pickup traces the track of the recording medium.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a view showing an optical system of a conventional near field recording/reproducing apparatus;

FIG. 2 is a view showing an example of a tracking error signal and a gap error signal;

FIG. 3 is a view showing an example of a gap error signal including noise;

FIG. 4 is a view showing the configuration of a data recording/reproducing apparatus according to a first embodiment of the present invention;

FIG. 5 is a view showing an example of a head shown in FIG. 4;

FIG. 6 is a view showing an example of an optical detecting unit according to the present invention;

FIG. 7 is a flowchart illustrating an example of a data recording/reproducing method according to the present invention;

FIG. 8 is a graph showing a variation in gap between a head and a recording medium over time in the data recording/reproducing method illustrated in FIG. 7;

FIG. 9 is a flowchart illustrating another example of the data recording/reproducing method according to the present invention;

FIG. 10 is a graph showing a variation in gap between a head and a recording medium over time in the data recording/reproducing method illustrated in FIG. 9;

FIG. 11 is a view showing a data recording/reproducing apparatus according to a second embodiment of the present invention;

FIG. 12 is an example of a signal correcting unit shown in FIG. 11;

FIG. 13 is another example of the signal correcting unit shown in FIG. 11;

FIG. 14 is a flowchart illustrating another example of the data recording/reproducing method according to the present invention; and

FIG. 15 is a variation in gap between a head and a recording medium in the data recording/reproducing method illustrated in FIG. 14.

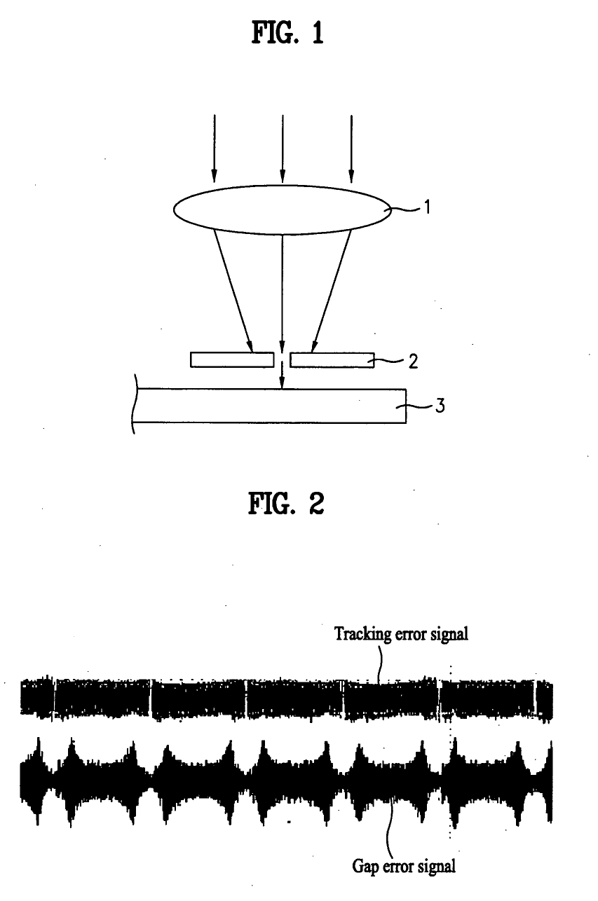

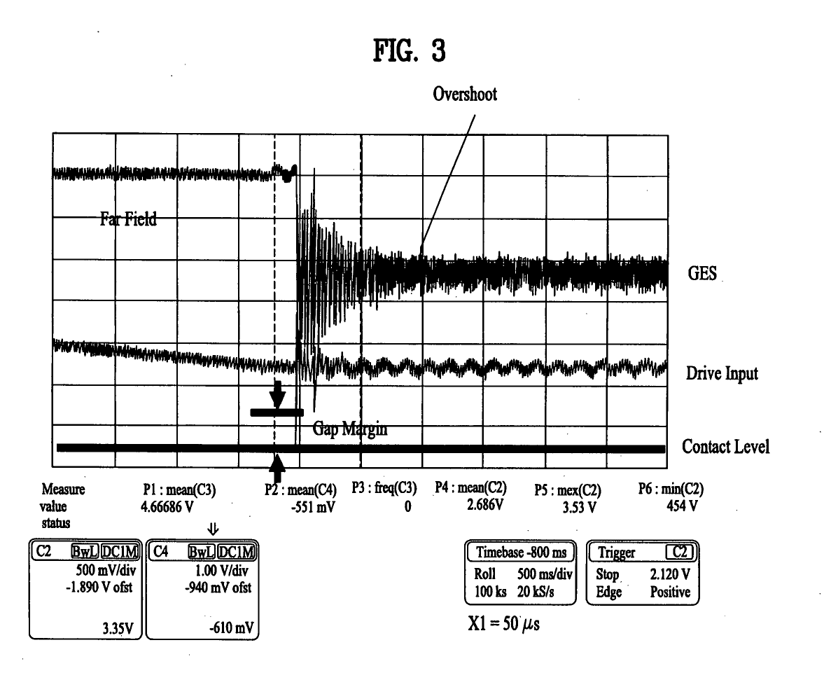

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

### First Embodiment

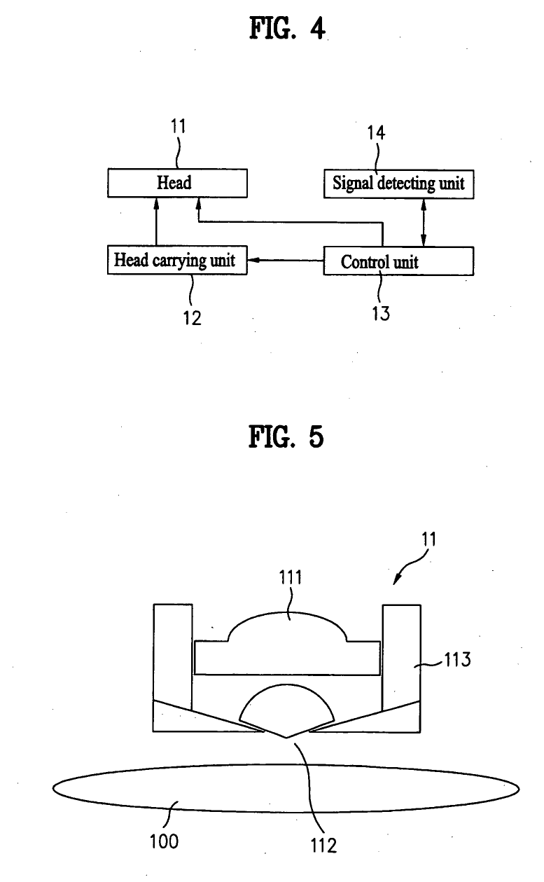

FIG. 4 is a view showing a data recording/reproducing apparatus according to a first embodiment of the present invention, in which general components are omitted and only components necessary for describing technical features of the present invention are shown. As shown in FIG. 4, the data recording/reproducing apparatus according to the present embodiment includes a head (pickup) 11, a head carrying unit 12, a control unit 13 and a signal detecting unit 14.

FIG. 5 is a view showing an example of the head, which includes an objective lens 111, a near field generating lens 112 located below the objective lens 111, and a lens holder 113 for fixing the objective lens 111 and the near field generating lens 112 at a predetermined gap. The objective lens 111 receives a laser beam output from a light source via a light guiding means such as an optical fiber, and focuses and guides the laser beam to the near field generating lens 112. The near field generating lens 112 has a refractive index higher than that of the objective lens 111. The laser beam passing through the objective lens 111 is refracted by the near field generating lens 112 to form a spot on the bottom thereof. The diameter of the formed spot is inversely proportional to the refractive index of the near field generating lens 112. Accordingly, it is possible to obtain a spot of a light beam having the diameter smaller than a diffraction limitation. The spot is guided in an evanescent wave such that high-density bit information is stored on a recording medium 100. The near field generating lens 112 is a solid-immersion lens (SIL) made of a material having a high refractive index, such as glass, and has the shape of a hemisphere or the shape of a super-hemisphere having a conical bottom. A coil is provided on the circumference of the near field generating lens 112. The coil is used for reversing a magnetic field in the vicinity of the near field generating lens 112 to form a recording mark.

The head carrying unit 12 is an actuator for moving the head 11, which is used for adjusting a gap between the head 11 and the recording medium 100 and accurately performing a tracking process. The recording medium may axially vibrate due to the twist of the recording medium by heat generated upon manufacturing the recording medium or eccentricity due to machining error of a central hole. The recording medium may axially vibrate due to the weight of the recording medium or the inclination of the recording/reproducing apparatus. In order to remove the error due to a variety of causes, maintain the gap between the head 11 and the recording medium 100 and accurately perform the tracking process, a servo technology is required. Accordingly, the head carrying unit 12 may move the head 11 in a vertical direction or a horizontal direction.

The signal detecting unit 14 detects an RF signal, a gap error signal and a tracking error signal from the light beam reflected from the recording medium 100. The RF signal indicates the amount of a light beam incident to the recording medium 100, and the gap error signal indicates whether the spot of the light beam incident to the recording medium 100 is focused and the gap between the head 11 and the recording medium 100. The tracking error signal indicates whether the head 11 is eccentric, that is, whether the incident light beam is deviated from a track. The signal detecting unit 14 includes at least one photo detector.

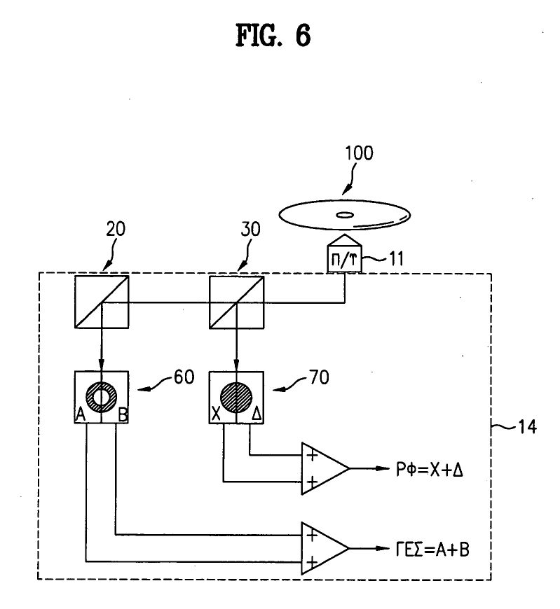

FIG. 6 is an example of the signal detecting unit according to the present invention. As shown in FIG. 6, the light beam received by the head is sent to a first optical path converter 20 and a second optical path converter 30. The first optical path converter 20 passes through only light, which is polarized in a specific direction, according to a polarization direction and the second optical path converter 30 passes through a part of the light and reflects the remaining thereof. First and second signal detectors 60 and 70 receive the light beams from the first and second optical path converters 20 and 30 and generate electrical signals corresponding to the amounts of the light beams, respectively. The first and second signal detectors 60 and 70 may include a plurality (for example, two or four) of photo detectors. When the first and second signal detectors 60 and 70, for example, include two photo detectors, the sum of signals A and B output from the first signal detector 60 is the gap error signal and the sum of signals C and D output from the second signal detector 70 is the RF signal. When the head 11 moves away from the recording medium 100 to be deviated from the near field, the light beam which reaches the recording medium 100 is totally reflected. Accordingly, when the intensity of the reflected light is a maximum and the sum of the signals A and B is a maximum, it can be seen that the head is deviated from the near field. That is, it is possible to judge a proper gap between the head 11 and the recording medium 100 using the intensity of the reflected light.

The control unit 13 performs a gap servo (focus servo) process for adjusting the gap between the head 11 and the recording medium 100, and more particularly, the gap between the near field generating lens 112 of the head 11 and the recording medium 100 on the basis of the RF signal and the gap error signal detected by the signal detecting unit 14 and a tracking servo process for moving the head 11 along the track of the recording medium 100 on the basis of the detected tracking error signal. Alternatively, the recording/reproducing apparatus may include a double servo system (control unit). For example, the double servo system includes a first servo part (main servo part) for performing a tracking servo process and a coarse gap servo process and a second servo part (sub-servo part) embedded in the head 11 for performing a fine gap servo process.

Examples of a data recording/reproducing method using the data recording/reproducing apparatus will now be described.

### Example 1

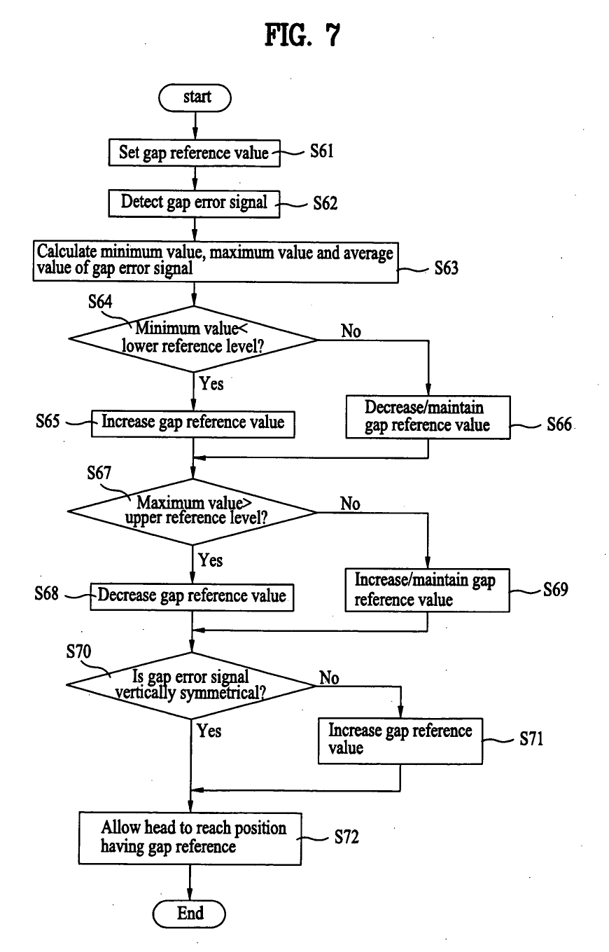

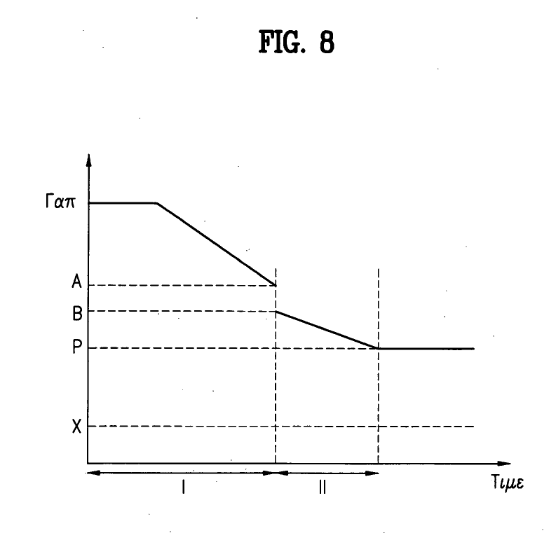

FIG. 7 is a flowchart illustrating Example 1 of the data recording/reproducing method according to the present invention and FIG. 8 is a view showing a process for allowing the head to approach the recording medium.

When a record command or a reproduction command is input, the control unit 13 sets a gap reference value R (for example, 20 nm) between the head 11 and the recording medium 100 (S61). The gap reference value R is a gap suitable for recording or reproducing data, which is set on the basis of a reference value set when manufacturing the data recording/reproducing apparatus or a gap (reference value) used upon a previous recording/reproducing process.

Next, the control unit 13 begins a primary approaching process I for allowing the head 11 to approach the recording medium 100 at a predetermined speed (for example, several mm/sec) while rotating the recording medium 100 at a predetermined rotation speed. The primary approach section I is called approach.

When a predetermined time elapses or the head reaches a position having a predetermined gap A, the control unit 13 finishes the primary approaching process I and begins a secondary approaching process II for allowing the head 11 to approach the recording medium 100 at a speed which is lower than that of the primary approaching process I. The secondary approaching process II is called hand-over or pull-in. During the secondary approaching process II, the signal detecting unit 14 detects the gap error signal (S62).

Although the position A of the head 11 when the primary approaching process I is finished and the position B when the secondary approaching process starts are different in FIG. 8, the positions A and B may be set to be identical.

When the secondary approaching process II starts, the control unit 13 obtains/calculates a minimum value (minimum voltage value), a maximum value (maximum voltage value) and an average value of the gap error signal detected by the signal detecting unit 14 (S63). At this time, the control unit 13 obtains the minimum value, the maximum value and the average value of the gap error signal obtained during rotation of the recording medium 100 a predetermined number of times. The control unit 13 compares the minimum value of the detected gap error signal with a lower reference level (S64). The lower reference level is obtained by converting a minimum gap for recording/reproducing data into a voltage unit, or converting a contact level C for allowing the head 11 to contact the recording medium 100 into a voltage unit, or a predetermined gap (for example, 10 nm) into a voltage unit. It is apparent that the lower reference level may be set to a variety of values, which are not suggested in the present invention.

When the minimum value of the gap error signal is smaller than the lower reference level, since the head 11 may contact or collide with the recording medium 100, the control unit 13 increases the gap reference value R (S65). In contrast, when the minimum value of the gap error signal is equal to or larger than the lower reference level, the control unit 13 decreases or maintains the gap reference value R (S66).

The control unit 13 compares the maximum value of the detected gap error signal with an upper reference level (S67). The upper reference level is obtained by converting a maximum gap for recording/reproducing data into a voltage unit, converting the position B of the head 11 when the secondary approaching process II starts into a voltage unit, or converting a predetermined gap (for example, 50 nm) into a voltage unit. It is apparent that the upper reference level may be set to a variety of values, which are not suggested in the present invention.

When the maximum value of the gap error signal is larger than the upper reference level, the control unit 13 determines that the head 11 is located at a position where the data is unlikely to be accurately recorded/reproduced and decreases the gap reference value R (S68). In contrast, when the maximum value of the gap error signal is equal to or smaller than the upper reference level, the control unit 13 increases or maintains the gap reference value R (S69).

When the gap reference value R is adjusted on the basis of the minimum value and the maximum value of the gap error signal, the gap reference value R should be adjusted such that the minimum value and the maximum value are in a range from the lower reference level to the upper reference level. When the minimum value and the maximum value are in the range from the lower reference level to the upper reference level, the head 11 is located at a position where the data can be recorded/reproduced in a state that the head 11 does not contact the recording medium 100.

The order of the step S64 of comparing the minimum value of the gap error signal with the lower reference level and the step S67 of comparing the maximum value of the gap error signal with the upper reference level may be reversed.

As a selective step, the control unit 13 determines whether the gap error signal is vertically symmetrical (S70). Generally, when the head 11 contacts the recording medium 100, the gap error signal is asymmetrical. Accordingly, in order to determine whether the head 11 contacts the recording medium 100, the control unit 13 determines whether the gap error signal is vertically symmetrical.

In order to determine whether the gap error signal is vertically symmetrical, the control unit 13 calculates a difference (the maximum value—the average value) between the maximum value and the average value of the gap error signal and a difference (the average value—the minimum value) between the average value and the minimum value of the gap error signal and determines whether the differences are identical. If the differences are identical, the gap error signal is vertically symmetrical and the control unit 13 maintains the gap reference value R. In contrast, if the differences are not identical, the gap error signal is asymmetrical and the control unit 13 readjusts the gap reference value R. For example, when the differences are not identical, the control unit 13 adjusts the gap reference value R on the basis of the minimum value and the maximum value of the gap error signal as described above or increases the gap reference value R until the gap error signal is vertically symmetrical (S71).

The control unit 13 allows the head 11 to approach the recording medium until the head reaches a position having the initially set gap reference value R, when the gap reference value R is not changed; and allows the head 11 to approach the recording medium until the head reaches a position having the changed gap reference value R, when the gap reference value is changed (S72). Then, the control unit 13 records the data on the recording medium 100 or reproduces the data from the recording medium 100. The adjustment of the gap reference value R may be repeatedly performed during the secondary approaching process II or during recording or reproducing the data.

### Example 2

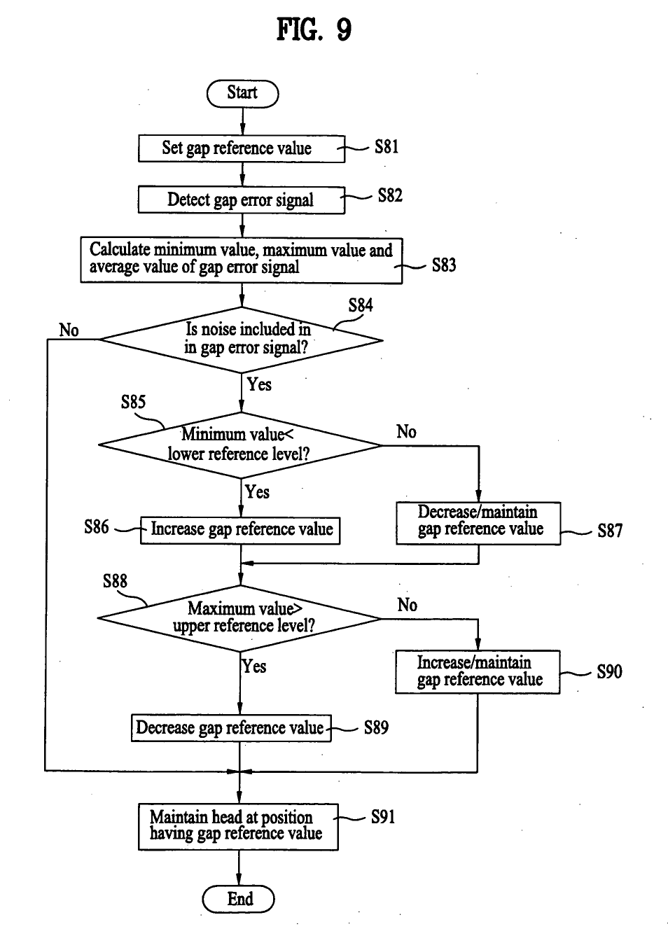

FIG. 9 is a flowchart illustrating Example 2 of the data recording/reproducing method according to the present invention. The data recording/reproducing method will now be described with reference to FIG. 9. FIG. 10 is a view showing a process for allowing the head to approach the recording medium.

First, the control unit 13 sets a gap reference value R′ using the same method as Example 1 (S81) and allows the head 11 to approach the recording medium 100 at a predetermined speed (for example, several mm/sec) while rotating the recording medium 100 at a predetermined rotation speed. At this time, the signal detecting unit 14 detects the gap error signal (S82) and the control unit 13 obtains/calculates a minimum value, a maximum value and an average value of the gap error signal detected by the signal detecting unit 14 (S83).

The control unit 13 determines whether noise is included in the detected gap error signal (S84). The noise indicates an interference component due to the other signals or deformation/damage of the gap error signal due to a variety of factors of the data recording/reproducing apparatus or the recording medium. In order to determine whether the noise is included in the gap error signal, the control unit 13 uses a difference between the maximum value and the minimum value of the gap error signal.

The control unit 13 compares the difference (the maximum value—the minimum value) with a reference value or determines whether the difference falls in a predetermined range and determines whether the noise is include in the gap error signal according to the result of comparison or determination and adjusts the gap reference value R′. The reference value and the predetermined range may be set on the basis of the difference between the maximum value and the minimum value of the normal gap error signal without noise, that is, the amplitude (peak-to-peak) of the normal gap error signal or may be set to another value.

When the difference (the maximum value—the minimum value) is larger than the reference value, the control unit 13 determines that the noise is included in the gap error signal and adjusts the gap reference value R′ on the basis of the maximum value and the minimum value.

When the difference (the maximum value—the minimum value) is out of the predetermined range, the control unit 13 determines that noise is included in the gap error signal and adjusts the gap reference value R′ on the basis of the maximum value and the minimum value.

When the noise is included in the gap error signal, a method for adjusting the gap reference value R′ on the basis of the maximum value and the minimum value of the gap error signal is performed as follows:

The control unit 13 compares the minimum value of the detected gap error signal with a lower reference level (S85). The lower reference level is obtained by converting a minimum gap for allowing the head 11 to approach the recording medium 100 into a voltage unit, converting a contact level C for allowing the head 11 to contact the recording medium 100 into a voltage unit, or a predetermined gap (for example, 10 nm) into a voltage unit.

When the minimum value of the gap error signal is smaller than the lower reference level, since the head 11 may contact or collide with the recording medium 100, the control unit 13 increases the gap reference value R′ (S86). In contrast, when the minimum value of the gap error signal is equal to or larger than the lower reference level, the control unit 13 decreases or maintains the gap reference value R′ (S87).

The control unit 13 compares the maximum value of the detected gap error signal with an upper reference level (S88). The upper reference level is obtained by converting a maximum gap for recording/reproducing data into a voltage unit or converting a predetermined gap (for example, 50 nm) into a voltage unit.

When the maximum value of the gap error signal is larger than the upper reference level, the control unit 13 determines that the head 11 is located at a position where the data is unlikely to be accurately recorded/reproduced and decreases the gap reference value R′ (S89). In contrast, when the maximum value of the gap error signal is equal to or smaller than the upper reference level, the control unit 13 increases or maintains the gap reference value R′ (S90).

When noise is not included in the gap error signal, the control unit 13 maintains the gap reference value R′ and allows the head 11 to approach the recording medium until the head reaches a position having the gap reference value R′.

As a selective step, the control unit 13 determines whether the gap error signal is vertically symmetrical in order to determine whether the head 11 contacts the recording medium 100. In order to determine whether the gap error signal is vertically symmetrical, the control unit 13 calculates a difference (the maximum value—the average value) between the maximum value and the average value of the gap error signal and a difference (the average value—the minimum value) between the average value and the minimum value of the gap error signal and determines whether the differences are identical. The gap reference value R′ can be adjusted by the result of determination. A method for adjusting the gap reference value R′ according the vertical symmetry of the gap error signal is identical to that of Example 1.

### Second Embodiment

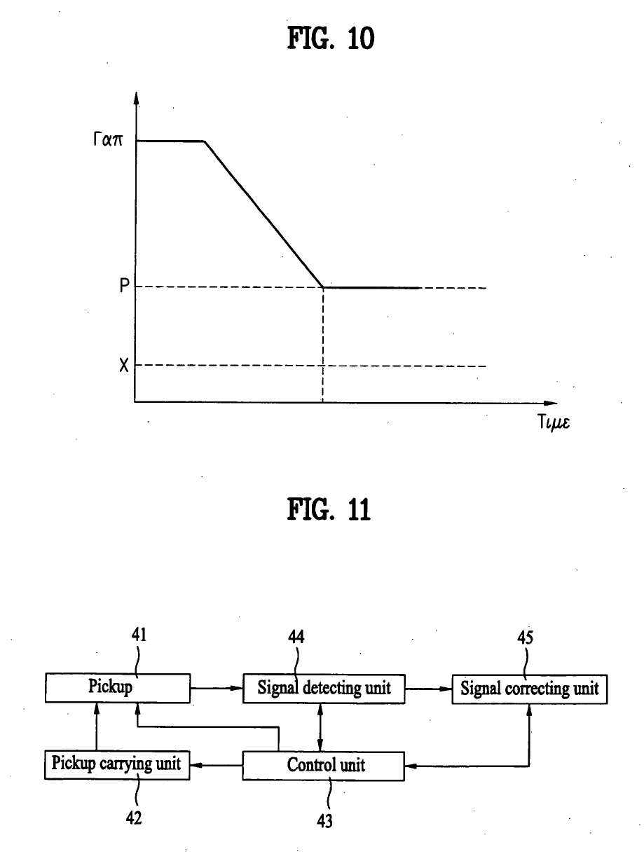

FIG. 11 is a view showing a data recording/reproducing apparatus according to a second embodiment of the present invention, in which general components are omitted and only components necessary for describing technical features of the present invention are shown. As shown in FIG. 11, the data recording/reproducing apparatus according to the present embodiment includes a head (pickup) 41, a head carrying unit 42, a control unit 43, a signal detecting unit 44 and a signal correcting unit 45.

The head 41, the head carrying unit 42 and the signal detecting unit 44 are identical to the head 11, the head carrying unit 12 and the signal detecting unit 14 of the first embodiment, respectively. The signal correcting unit 45 detects a differential component of the gap error signal and removes noise included in the gap error signal on the basis of the detected differential component. Although the signal detecting unit 44 and the signal correcting unit 45 are separately provided in FIG. 11, the signal detecting unit 44 and the signal correcting unit 45 may be configured as a single unit.

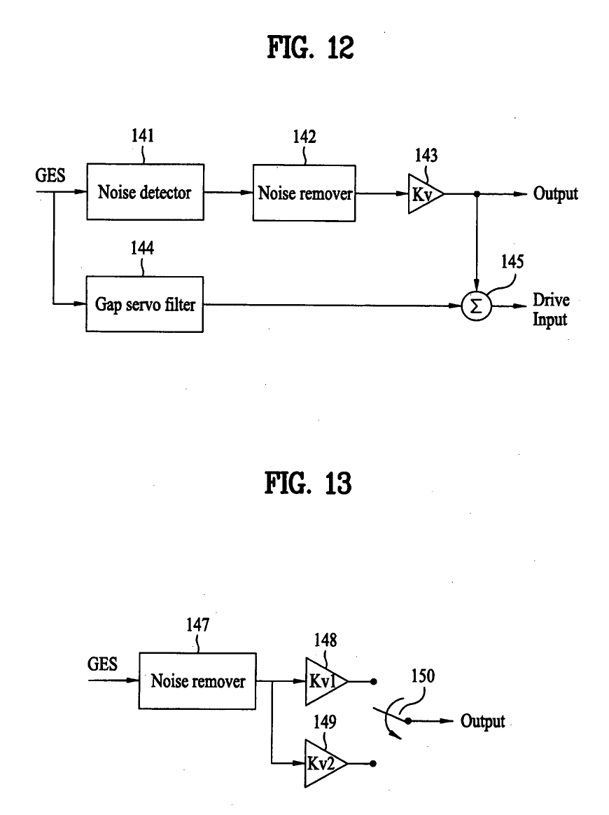

FIG. 12 is an example of the signal correcting unit 45 and shows only parts necessary for detecting and removing the noise. Referring to FIG. 12, a noise detector 141 detects the differential value of the gap error signal detected by the signal detecting unit 44, that is, a variation in the level of the gap error signal over time. The noise detector 141 determines that the noise is included in the gap error signal when the differential value of the gap error signal is equal to or larger than a reference value. When the differential value is equal to or larger than the reference value, since the variation in the level of the gap error signal is large, a noise remover 142 decreases a peak value of the gap error signal to be smaller than the reference value. The noise remover 142 may be a low pass filter which outputs only signals below a specific frequency band. Since the frequency band of the gap error signal is about 0 to 30 KHz, the low pass filter removes a high frequency signal higher than 30 KHz. A gain adjuster (Kv) 143 adjusts a gain of the signal output from the noise remover 142. When the level of the signal output from the noise remover 142 is too small, the gain adjuster 143 increases the gain of the signal. The signal output from the gain adjuster 143 is used as the corrected gap error signal (output signal) or sent to a signal combiner 145.

A gap servo filter 144 outputs only a specific frequency band of the gap error signal detected by the signal detecting unit 44. The gap servo filter 144 is used for generating a drive input. The drive input controls the head 41. In particular, the drive input is used as a control signal for adjusting the gap between the head 41 and the recording medium 100.

The signal combiner 145 receives two signals output from the gain adjuster 143 and the gap servo filter 144. When the noise is included in the gap error signal (when the differential value is equal to or larger than the reference value), the signal combiner 145 combines the two signals and outputs the combined signal, and, when the noise is not included in the gap error signal (when the differential value is smaller than the reference value), the signal combiner 145 outputs only the signal output from the gap servo filter 144. That is, since compensation using the differential component is ineffective in a normal state, the differential value is not added to the drive input. The selective signal output of the signal combiner 145 may be decided by the differential value or a command of the control unit 43.

FIG. 13 is another example of the signal correcting unit 45 and shows only parts necessary for detecting and removing the noise. Referring to FIG. 13, a noise remover 147 removes the noise using the differential value of the gap error signal detected by the signal detecting unit 44. That is, when the differential value of the gap error signal is equal to or larger than the reference value, a peak value of the gap error signal is reduced so as to be smaller than the reference value. The noise remover 147 may include a low pass filter which outputs only signals below a specific frequency band. First and second gain adjusters (Kv1 and Kv2) 148 and 149 receive the signal output from the noise remover 147 and adjust the gain of the received signal to different levels. The gain of the first gain adjuster 148 is larger than that of the second gain adjuster 149.

A switch 150 outputs the gap error signal of which the gain is adjusted by the first gain adjuster 148 when the noise is included in the gap error signal and outputs the gap error signal of which the gain is adjusted by the second gain adjuster 149 when the noise is not included in the gap error signal. That is, since the noise is hardly included in the gap error signal in the normal state, the noise is hardly removed and thus the gain of the gap error signal does not need to be larger than that of the gap error signal in which the noise is included.

The control unit 43 controls a gap servo process (focus servo process) for adjusting the gap between the head 11 and the recording medium 100, and more particularly, the gap between the near field generating lens 112 of the head 41 and the recording medium 100, on the basis of the corrected gap error signal output from the signal correcting unit 45. The control unit 43 sets a primary gap reference value and performs a primary gap servo process on the basis of the primary gap reference value. Then, the control unit 43 controls a tracking servo process for moving the head 41 along a track of the recording medium 100 on the basis of a detected tracking error signal. Next, the control unit 43 sets a secondary gap reference value and controls a secondary gap servo process on the basis of the secondary gap reference value.

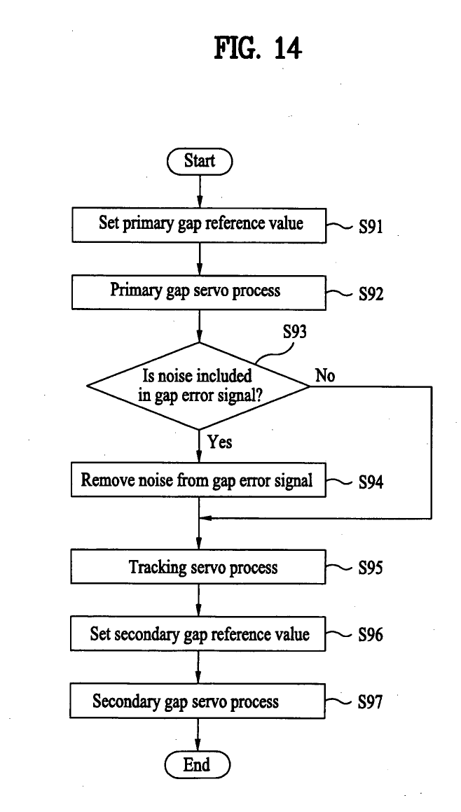

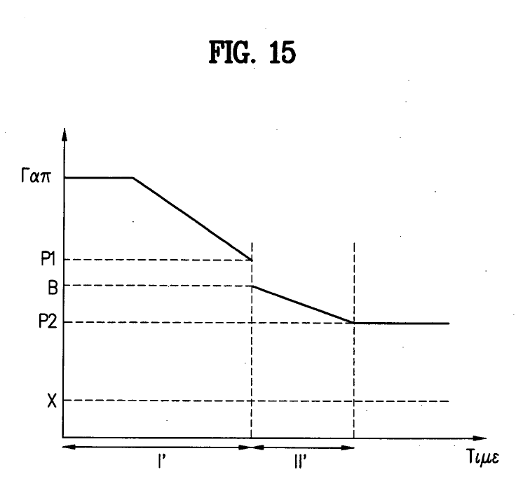

FIG. 14 is a flowchart illustrating a data recording/reproducing method using the data recording/reproducing apparatus according to the second embodiment. The data recording/reproducing method will now be described with reference to FIG. 14. In particular, the gap servo process performed when the data is recorded or reproduced will be described.

When the recording medium 100 is loaded into the recording/reproducing apparatus (or a drive) or a record command or a reproduction command is input, the control unit 43 sets a primary gap reference value R1 (for example, 50 to 60 nm) between the head 41 and the recording medium 100 (S91). The primary gap reference value R1 is an initial reference gap for allowing the head 41 to approach the recording medium 100, which is set on the basis of a reference value set when manufacturing the data recording/reproducing apparatus or a gap (reference value) used on a previous recording/reproducing process.

Next, as shown in FIG. 15, the control unit 43 begins a primary gap servo process (primary approaching process) I′ for allowing the head 41 to approach the recording medium 100 at a predetermined speed (for example, several mm/sec) while rotating the recording medium 100 at a predetermined rotation speed (S92). At this time, the gap error signal is detected by the head 41 and the signal detecting unit 44.

The signal correcting unit 45 detects the differential value of the detected gap error signal. The signal correcting unit 45 determines whether the noise is included in the gap error signal, on the basis of the detected differential value (S93). For example, when the differential value is equal to or larger than the reference value, it is determined that the noise is included in the gap error signal. As another embodiment, instead of the signal correcting unit 45, the control unit 43 may determine whether the noise is included in the gap error signal on the basis of the differential value.

When the noise is not included in the gap error signal, the head 41 is allowed to approach the recording medium 100 until the head reaches a position having the primary gap reference value. In contrast, when the noise is included in the gap error signal, the noise is removed by the signal correcting unit 45 (S94), the gain of the gap error signal from which the noise is removed is adjusted, and the gap error signal of which the gain is adjusted is output. When the noise is removed from the gap error signal, malfunction due to the gap error signal is not generated and thus a stable gap servo process can be performed.

When the noise is removed from the gap error signal and the head reaches the position having the primary gap reference gap, the control unit 43 begins the tracking servo process (S95). During the tracking servo process, the tracking error signal is detected by the signal detecting unit 44. The signal detecting unit 44 outputs the detected tracking error signal having a predetermined level or less. The head 41 stably traces the track of the recording medium without colliding with the recording medium 100 by restricting the tracking error signal to be equal to or smaller than the predetermined level and performing the tracking servo process between the primary gap servo process I′ and a secondary gap servo process II′ (in a state where a sufficient gap margin is ensured). Accordingly, a large variation (X-talk) in amplitude of the tracking error signal is reduced and thus an unstable gap servo process due to an interference component of the tracking error signal can be prevented.

When the tracking servo process is stably performed as described above, the control unit 43 sets a secondary gap reference value R2 (for example, 20 nm) between the head 41 and the recording medium 100 (S96). The secondary gap reference value R2 is a final reference gap for allowing the head 41 to approach the recording medium 100, which is set on the basis of a reference value set when manufacturing the data recording/reproducing apparatus or a gap (reference value) used upon a previous recording/reproducing process.

Subsequently, the control unit 43 begins the secondary gap servo process (secondary approaching process) II′ for allowing the head 41 to approach the recording medium 100 at a speed lower than that of the primary gap servo process (S97). Even during the secondary approaching process II′, the signal detecting unit 44 detects the gap error signal. The control unit 43 obtains and adjusts the gap between the head 41 and the recording medium 100 on the basis of the gap error signal.

When the head 41 reaches a position having the secondary gap reference value R2, the control unit 43 records or reproduces data on/from the recording medium 100 while maintaining the secondary gap reference value R2 according to a command of a user.

As described above, since the secondary gap servo process (final gap servo process) starts after the primary gap servo process and the tracking servo process are stably performed, it is possible to minimize the noise of the gap error signal due to interference of the tracking error signal. Furthermore, it is possible to minimize the noise by detecting and removing the noise of the gap error signal, which may be generated when the gap servo process starts, on the basis of a differential component thereof.

### INDUSTRIAL APPLICABILITY

According to the present invention, it is possible to stably control a gap between a head and a recording medium by adjusting the gap (gap reference value) between the head and the recording medium on the basis of a minimum value and a maximum value of a gap error signal. In addition, since it is determined whether the gap error signal is interfered or deformed on the basis of the minimum value and the maximum value of the gap error signal, it is possible to accurately adjust the gap between the head and the recording medium.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. A data recording/reproducing method comprising:
outputting at least one signal based on a light beam reflected from a recording medium;
detecting a minimum value and a maximum value of the output signal; and
adjusting a gap between a head of a data recording/reproducing apparatus and the recording medium according to the minimum value and the maximum value.

2. The method according to claim 1, wherein the step of outputting at least one signal comprises outputting an RF signal indicating the amount of the light beam incident to the recording medium, a gap error signal indicating whether a spot of the light beam incident to the recording medium is focused and the gap between the head and the recording medium, and a tracking error signal indicating whether the head is eccentric.

3. The method according to claim 1, wherein the step of adjusting the gap between the head and the recording medium according to the minimum value and the maximum value comprises:
comparing the minimum value and the maximum value with a lower reference value and an upper reference value, respectively; and
adjusting the gap between the head and the recording medium according to the result of comparison.

4. The method according to claim 3, wherein the step of adjusting the gap between the head and the recording medium according to the result of comparison comprises increasing the gap between the head and the recording medium when the minimum value is smaller than the lower reference value.

5. The method according to claim 3, wherein the step of adjusting the gap between the head and the recording medium according to the result of comparison comprises decreasing the gap between the head and the recording medium when the maximum value is larger than the upper reference value.

6. The method according to claim 1, further comprising adjusting the gap between the head and the recording medium on the basis of vertical symmetry of the output signal.

7. The method according to claim 6, wherein the vertical symmetry of the output signal is determined by determining whether a difference between the maximum value and an average value of the output signal and a difference between the average value and the minimum value are identical.

8. The method according to claim 6, further comprising adjusting the gap between the head and the recording medium when the output signal is vertically asymmetrical.

9. A data recording/reproducing apparatus comprising:
a head for irradiating a light beam onto a recording medium and receiving the light beam reflected from the recording medium;
a signal output unit for outputting at least one signal on the basis of the light beam reflected from the recording medium;
a head carrying unit for moving the head; and
a control unit for adjusting a gap between the head and the recording medium according to a minimum value and a maximum value of the signal output from the signal output unit.

10. The apparatus according to claim 9, wherein the signal output unit outputs an RF signal indicating the amount of the light beam incident to the recording medium, a gap error signal indicating whether a spot of the light beam incident to the recording medium is focused and the gap between the head and the recording medium, and a tracking error signal indicating whether the head is eccentric.

11. The apparatus according to claim 9, wherein the control unit compares the minimum value and the maximum value with a lower reference value and an upper reference value, respectively, and adjusts the gap between the head and the recording medium according to the result of comparison.

12. The apparatus according to claim 11, wherein the control unit increases the gap between the head and the recording medium when the minimum value is smaller than the lower reference value.

13. The apparatus according to claim 11, wherein the control unit decreases the gap between the head and the recording medium when the maximum value is larger than the upper reference value.

14. The apparatus according to claim 9, wherein the control unit adjusts the gap between the head and the recording medium on the basis of vertical symmetry of the output signal.

15. The apparatus according to claim 14, wherein the control unit determines whether the output signal is vertically symmetrical by determining whether a difference between the maximum value and an average value of the output signal and a difference between the average value of the output signal and the minimum value are identical.

16. The apparatus according to claim 14, wherein the control unit adjusts the gap between the head and the recording medium when the output signal is vertically asymmetrical.

17. A data recording/reproducing method comprising:
setting a gap reference value between a head of a data recording/reproducing apparatus and a recording medium;
outputting a signal based on a light beam reflected from the recording medium;
determining whether noise is included in the output signal; and
adjusting the gap reference value according to the result of determination.

18. The method according to claim 17, wherein the step of determining whether the noise is included in the output signal comprises determining whether the noise is included on the basis of a difference between a maximum value and a minimum value of the output signal.

19. The method according to claim 17, further comprising adjusting the gap reference value on the basis of the maximum value and the minimum value of the output signal, when the noise is included in the output signal.

20. The method according to claim 19, wherein the gap reference value increases when the minimum value is smaller than a lower reference value and the gap reference value decreases when the maximum value is larger than an upper reference value.

21. A data recording/reproducing apparatus comprising:
a signal output unit for outputting a signal indicating a gap between a head and a recording medium; and
a control unit for initially setting a gap reference value between the head and the recording medium and adjusting the gap reference value depending on whether noise is included in the signal output from the signal output unit.

22. The apparatus according to claim 21, wherein the control unit determines whether the noise is included on the basis of a difference between a maximum value and a minimum value of the output signal.

23. The apparatus according to claim 21, wherein the control unit adjusts the gap reference value on the basis of a maximum value and a minimum value of the output signal, when the noise is included in the output signal.

24. The apparatus according to claim 23, wherein the control unit increases the gap reference value when the minimum value is smaller than a lower reference value and decreases the gap reference value when the maximum value is larger than an upper reference value.

25. A data recording/reproducing method comprising:
outputting a signal based on a light beam reflected from a recording medium;
removing noise included in the signal according to a variation in the level of the signal; and
controlling a gap between a pickup of a data recording/reproducing apparatus and the recording medium according to the signal from which the noise is removed.

26. The method according to claim 25, wherein the removing step comprises:
determining whether the noise is included in the signal on the basis of the variation in the level of the signal; and
decreasing a maximum value of the signal to be smaller than a reference value when the noise is included in the signal.

27. The method according to claim 26, wherein the decreasing step comprises passing the signal through a filter for outputting a signal in a predetermined frequency band.

28. The method according to claim 25, further comprising adjusting a gain of the signal from which the noise is removed.

29. The method according to claim 25, wherein the output signal is a gap error signal indicating whether a spot of the light beam irradiated to the recording medium is focused and the gap between the pickup and the recording medium.

30. A data recording/reproducing apparatus comprising:
a pickup for irradiating a light beam onto a recording medium and receiving the light beam reflected from the recording medium;
a signal correcting unit for removing noise included in a signal according to a variation in the level of a signal detected from the light beam reflected from the recording medium;
a pickup carrying unit for moving the pickup; and
a control unit for controlling a gap between the pickup and the recording medium according to the signal from which the noise is removed.

31. The apparatus according to claim 30, wherein the signal correcting unit comprises:
a noise detector for determining whether the noise is included in the signal, on the basis of the variation in the level of the signal; and
a noise remover for removing the noise from the signal.

32. The apparatus according to claim 31, wherein the noise remover is a filter for outputting the signal in a predetermined frequency band.

33. The apparatus according to claim 31, wherein the signal correcting unit further comprises at least one gain adjuster for adjusting a gain of the signal.

34. The apparatus according to claim 30, wherein the signal correcting unit comprises:
a noise remover for removing the noise from the signal on the basis of the variation in the level of the signal;
first and second gain adjusters for adjusting a gain of the signal to different levels;
a switch for selectively connecting the noise remover to the first gain adjuster or the second gain adjuster depending on whether the noise is included.

35. A data recording/reproducing method comprising:
primarily allowing a pickup of a data recording/reproducing apparatus to approach a recording medium to reach a position having a first reference gap;
performing a tracking servo process such that the pickup traces a track of the recording medium when the pickup reaches the position having the first reference gap; and
secondarily allowing the pickup to approach the recording medium to reach a position having a second reference gap when the pickup traces the track of the recording medium.

36. The method according to claim 35, wherein the first reference gap is 50 to 60 nm.

37. The method according to claim 35, wherein the second reference gap is 20 nm.

38. The method according to claim 35, wherein the step of secondarily allowing the pickup to approach the recording medium comprises secondarily allowing the pickup to approach the recording medium at a speed lower than that of the primary approaching step.

39. The method according to claim 35, wherein at least one of the steps of primarily and secondarily allowing the pickup to approach the recording medium comprises:
outputting a signal based on a light beam reflected from the recording medium; and
removing noise included in the signal according to a differential value of the signal.

40. The method according to claim 39, wherein the step of removing the noise comprises:
determining whether the noise is included in the signal on the basis of the differential value of the signal; and
decreasing a maximum value of the signal to be smaller than a reference value when the noise is included in the signal.

41. A data recording/reproducing apparatus comprising:
a pickup carrying unit for primarily allowing a pickup to approach a recording medium to reach a position having a first reference gap and secondarily allowing the pickup to approach the recording medium to reach a position having a second reference gap; and
a control unit for controlling the pickup carrying unit such that the pickup traces a track of the recording medium, when the pickup reaches the position having the first reference gap, and controlling the pickup carrying unit such that the pickup reaches the position having the second reference gap, when the pickup traces the track of the recording medium.

42. The apparatus according to claim 41, wherein the first reference gap is 50 to 60 nm and the second reference gap is 20 nm.

43. The apparatus according to claim 41, wherein the pickup carrying unit allows the pickup to approach the recording medium at a speed lower than that of when the pickup primarily approaches the recording medium.

44. The apparatus according to claim 41, further comprising a signal correcting unit for removing noise included in a signal according to a variation in the level of a signal detected from a light beam reflected from the recording medium.

45. The apparatus according to claim 44, wherein the signal correcting unit determines whether the noise is included in the signal on the basis of a differential value of the signal and decreases a maximum value of the signal to be smaller than a reference value when the noise is included in the signal.
